(19) United States
(12) Patent Application Publication
(10) Pub. No.: US 2007/0184779 A1
(43) Pub. Date: Aug. 9, 2007

(54) Wireless communication device and method for searching for wireless communication device

(75) Inventors: Hee-yong Park, Suwon-si (KR); Seong-soo Kim, Seoul (KR); Joong-suk Park, Seongnam-si (KR); Jae-kwon Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/649,848

(22) Filed: Jan. 5, 2007

Related U.S. Application Data
(60) Provisional application No. 60/756,220, filed on Jan. 5, 2006.

(30) Foreign Application Priority Data
Apr. 25, 2006 (KR) 10-2006-0037271

(51) Int. Cl. H04B 7/00

(52) U.S. Cl. 455/41.2

(57) ABSTRACT

Provided is a method of searching for a wireless communication device. The method includes outputting a search signal in multiple output directions; and if a response signal for the search signal is received, mapping an identifier of a wireless communication device having transmitted the response signal and information about an output direction of the search signal.

### CROSS-REFERENCE TO RELATED APPLICATION

This application claims priority from Korean Patent Application No. 10-2006-0037271 filed on Apr. 25, 2006 in the Korean Intellectual Property Office, and U.S. Provisional Patent Application No. 60/756,220 filed on Jan. 5, 2006 in the United States Patent and Trademark Office, the disclosures of which are incorporated herein by reference in their entirety.

### BACKGROUND OF THE INVENTION

1. Field of the Invention

The present invention relates to a wireless communication technology, and more particularly, to a wireless communication device using high-frequency radio signals, whose wavelengths are in the order of millimeters, and a method of searching for a wireless communication device.

2. Description of the Prior Art

As wireless networks have been highlighted and transmission requests for a large amount of multimedia data increase, research is being conducted in order to provide a more effective transmission method within a wireless network environment. Considering the characteristics of a wireless network in which multiple wireless communication devices share and use given radio resources, if competition among them increases, there is a high possibility that valuable radio resources may be wasted due to collision during communication. In order to reduce such collision or loss and stably transmit/receive data, a Wireless Local Area Network (WLAN) uses a contention-based Distributed Coordination Function (DCF) or a non-contention-based Point Coordination Function (PCF), and a Wireless Personal Area Network (WPAN) uses a time division scheme referred to as channel time allocation.

When such methods are applied to a wireless network, it is possible to reduce collision to a certain degree and stably perform communication. However, it is still highly probable that collision may occur among transmission data, as compared to a wired network. This is because various factors disturbing stable communication such as multi-path, fading and interference, intrinsically exist in a wireless network environment. In addition, with the increase in the number of wireless communication devices participating in a wireless network, the possibility that problems including collision, loss, etc., may occur also increases.

Such collision requires retransmission, which has a large negative impact on throughput of a wireless network. Specifically, in the case of requesting higher Quality of Service (QoS) like Audio/Video data (AV data), it is very important to ensure as much bandwidth as possible by reducing the number of retransmissions.

Moreover, when considering a trend showing the increasing necessity to wirelessly transmit high quality video such as Digital Video Disk (DVD) video and High Definition Television (HDTV) among various home devices, it is necessary to provide a technical standard for continuously transmitting/receiving high quality video requiring a wider bandwidth.

At the present time, the IEEE 802.15.3c task group is establishing a technical standard for transmitting a large amount of data in a wireless home network. This standard referred to as so-called Millimeter Wave (mmWave) uses radio waves having a physical wavelength in the order of millimeters (i.e. a frequency of 30 to 300 GHz), respectively, for transmission of mass storage data. According to the prior art, such a frequency band is an unlicensed band, which has been limitedly used for a communication provider, radio wave astronomy, vehicle collision prevention, etc.

FIG. 1 is a diagram illustrating a comparison of a frequency band between standards of IEEE 802.11 series and a mmWave. In an IEEE 802.11b or an IEEE 802.11g, a carrier frequency is 2.4 GHz and a channel bandwidth is about 20 MHz. In an IEEE 802.11a or an IEEE 802.11n, a carrier frequency is 5 GHz and a channel bandwidth is about 20 MHz. Differently from these standards, the mmWave uses a carrier frequency of 60 GHz and has a channel bandwidth of about 0.5 to 2.5 GHz. Herein, it can be understood that the mmWave has a carrier frequency and a channel bandwidth higher and wider than those of the existing standards of IEEE 802.11 series.

If high-frequency radio signals having a wavelength in the order of millimeters are used, it is possible to obtain a very high data rate in units of Gbps, and to reduce an antenna size length below 1.5 mm. Thus, it is possible to achieve a single chip including an antenna. Further, since the attenuation ratio is very high, it is also possible to reduce interference among devices.

However, when the mmWave is used, since the coverage of a beam becomes shorter due to the high attenuation ratio as described above, it is difficult to transmit signals in an omni-direction. In order to address such a problem, it is necessary to generate a sharp beam. In such a case, since the beam is locally transferred, it is impossible to detect all adjacent wireless communication devices.

### SUMMARY OF THE INVENTION

Accordingly, the present invention has been made to address the above-mentioned problems occurring in the prior art, and it is an aspect of the present invention to easily search for wireless communication devices in a wireless network environment using ultrashort waves in the order of millimeters.

An aspect of the present invention is not limited to that stated above. Those of ordinary skill in the art will clearly recognize additional aspects in view of the following description of the present invention.

In accordance with one non-limiting embodiment of the present invention, there is provided a method of searching for a wireless communication device, the method including outputting a search signal in multiple output directions; and if a response signal for the search signal is received, mapping an identifier of the wireless communication device having transmitted the response signal and information about an output direction of the search signal.

In accordance with another non-limiting embodiment of the present invention, there is provided a method of searching for a wireless communication device, the method including receiving a search signal for searching for the wireless communication device; generating a response signal corresponding to the search signal; and outputting the response signal in an output direction corresponding to a reception direction of the search signal.

In accordance with another non-limiting embodiment of the present invention, there is provided a method of searching for a wireless communication device, the method including receiving a search signal for searching for the wireless communication device, the search signal having directivity; extracting information about predetermined an output direction from the search signal; generating a response signal including the extracted information about output direction; and outputting the response signal in an omni-direction.

In accordance with still another non-limiting embodiment of the present invention, there is provided a wireless communication device including a transmission/reception unit which outputs a search signal in multiple output directions and receives a response signal for the search signal; and a device information manager which maps an identifier of another wireless communication device having transmitted the response signal and information about an output direction of the search signal.

In accordance with yet another non-limiting embodiment of the present invention, there is provided a wireless communication device including a Media Access Control (MAC) processor which generates a response message corresponding to a search message for searching for another wireless communication device; and a transmission/reception unit which receives a search signal including the search message, provides the search message to the MAC processor, generates a response signal including the response message, and outputs the response signal in an output direction corresponding to a reception direction of the search signal.

In accordance with yet another non-limiting embodiment of the present invention, there is provided a wireless communication device including an MAC processor which extracts information about a predetermined output direction from a search message and generates a response message including the extracted information about output direction; and a transmission/reception unit which receives a search signal having directivity and including the search message, provides the search message to the MAC processor, generates a response signal including the response message, and outputting the response signal in an omni-direction.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a comparison of a frequency band between standards of IEEE 802.11 series and a mmWave;

FIG. 2 is a block diagram illustrating a wireless network system according to one non-limiting embodiment of the present invention;

FIG. 3 is a diagram illustrating a beam generated according to one non-limiting embodiment of the present invention;

FIG. 4 is a diagram illustrating adjustment of output directions of a beam according to one non-limiting embodiment of the present invention;

FIG. 5 is a flow diagram illustrating a process for searching for wireless communication devices according to one non-limiting embodiment of the present invention;

FIG. 6 is a flow diagram illustrating a process for searching for wireless communication devices in terms of a slave device according to one non-limiting embodiment of the present invention;

FIG. 7 is a diagram illustrating transmission of search signals and response signals through multiple channels;

FIG. 8 is a flow diagram illustrating a process for transmitting search signals according to one non-limiting embodiment of the present invention;

FIG. 9 is a flow diagram illustrating a process for receiving response signals according to one non-limiting embodiment of the present invention;

FIG. 10 is a flow diagram illustrating a process for searching for wireless communication devices in terms of a master device according to one non-limiting embodiment of the present invention;

FIGS. 11 and 12 are block diagrams illustrating a master device according to one non-limiting embodiment of the present invention; and

FIGS. 13 and 14 are block diagrams illustrating a slave device according to one non-limiting embodiment of the present invention.

### DETAILED DESCRIPTION OF EXEMPLARY EMBODIMENTS

Detailed particulars of additional non-limiting embodiments are included in the detailed description and drawings.

Advantages and features of the present invention, and ways to achieve them will be apparent from non-limiting embodiments of the present invention as will be described below together with the accompanying drawings. However, the scope of the present invention is not limited to such embodiments and the present invention may be realized in various forms. The non-limiting embodiments to be described below are provided to assist those skilled in the art to understand the present invention. The present invention is defined by the scope of the appended claims. Also, the same reference numerals are used to designate the same elements throughout the specification.

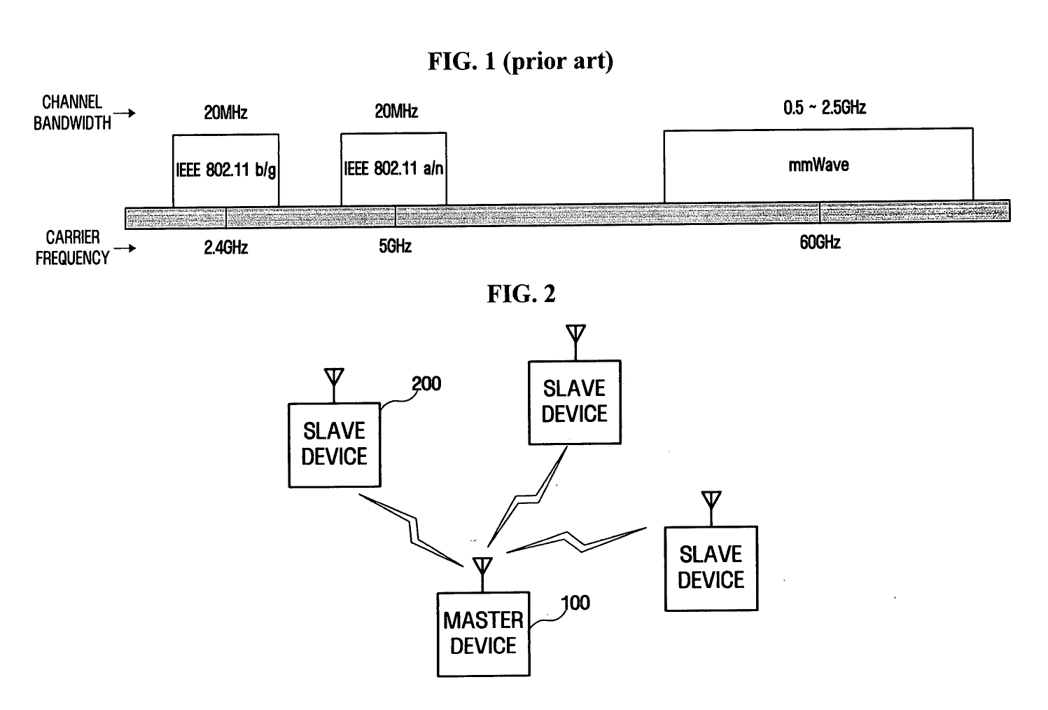

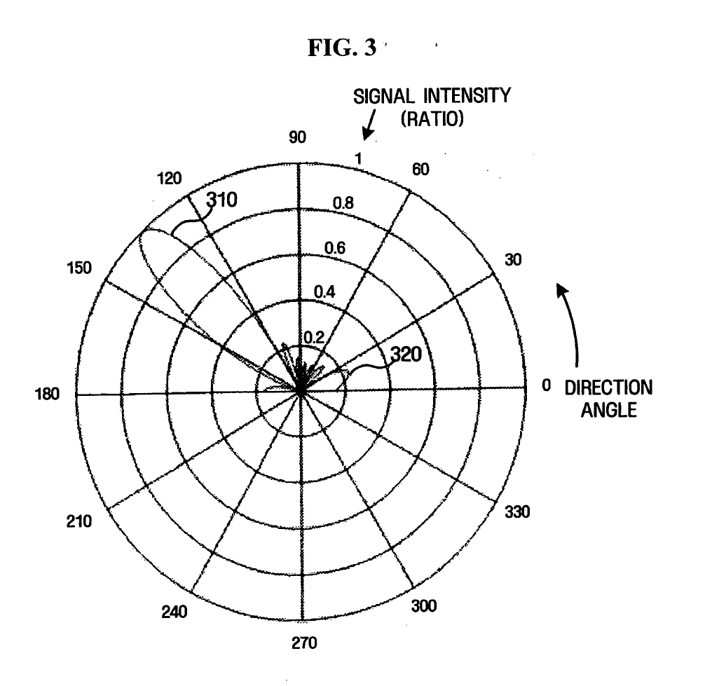

FIG. 2 is a block diagram illustrating a wireless network system according to one non-limiting embodiment of the present invention. The wireless network system as illustrated in FIG. 2 includes a master device 100 and one or more slave devices 200.

The master device 100 is a wireless communication device for performing wireless communication by using high-frequency radio signals having a wavelength in the order of millimeters, e.g. mmWave, and searching for the slave devices 200 existing around the master device 100. The master device 100 can be realized as an Access Point (AP), a PicoNet Coordinator (PNC) operating under the WPAN environment based on an IEEE 802.15.3, a Control Point (CP) under the Universal Plug and Play (UPnP) environment, etc.

The slave device 200 is a wireless communication device corresponding to the master device 100, which can be realized as a station operating under the WLAN environment based on an IEEE 802.11, a device operating under the WPAN environment based on an IEEE 802.15.3, a Controlled Device (CD) under the UPnP environment, etc. The slave device 200 also performs wireless communication by using high-frequency radio signals having a wavelength in the order of millimeters, e.g. mmWave, and can inform the master device 100 of its own existence by responding to the search operation of the master device 100.

Of course, it is possible that the slave device 200 is realized as an AP, a PNC or a CP, and the master device 100 is also realized as a station, a device or a CD, which corresponds to the slave device 200.

The high-frequency radio signals correspond to signals of a communication band including 60 GHz as illustrated in FIG. 1. Since the high-frequency radio signals have a short coverage, the master device 100 and the slave device 200 can form the radio signals into a sharp beam by using an array antenna. Since the formed beam has a pattern in which radiation power of each antenna element constituting the array antenna is accumulated, the coverage greatly increases.

FIG. 3 is a diagram illustrating a beam generated according to one non-limiting embodiment of the present invention. A beam generated using an array antenna may include one main lobe 310 and one or more side lobes 320. Of them, the main lobe 310 is used as a main medium for transmitting required data. Of course, the side lobe 320 may also be used as a main medium. However, when considering an object to increase a coverage, the side lobe 320 has little value.

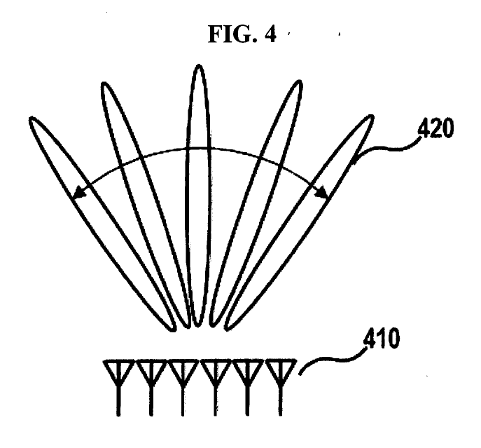

Laying emphasis on the main lobe 310, the generated beam has directivity. In the case of the beam as illustrated in FIG. 3, it can be understood that signals transmitted at a direction angle within the range of 120° to 150°, among a direction angle range of 0° to 360°, have a maximum intensity. If the generated beam has directivity as described above, since signals outputted from transmission devices (may include both the master device 100 and the slave device 200) are transferred to reception devices (may include both the master device 100 and the slave device 200) located in the output direction of a beam from the transmission devices, different reception devices cannot receive the signals outputted from the transmission devices. Accordingly, the master device 100 and the slave device 200 can adjust the output direction of a beam 420 by using a beam steering scheme as illustrated in FIG. 4, which illustrates only the main lobe of a beam outputted from an array antenna 410.

The master device 100 steers a beam having directivity to search for the slave devices 200 existing around the master device 100. Hereinafter, a process by which the master device 100 searches for the slave devices 200 will be described.

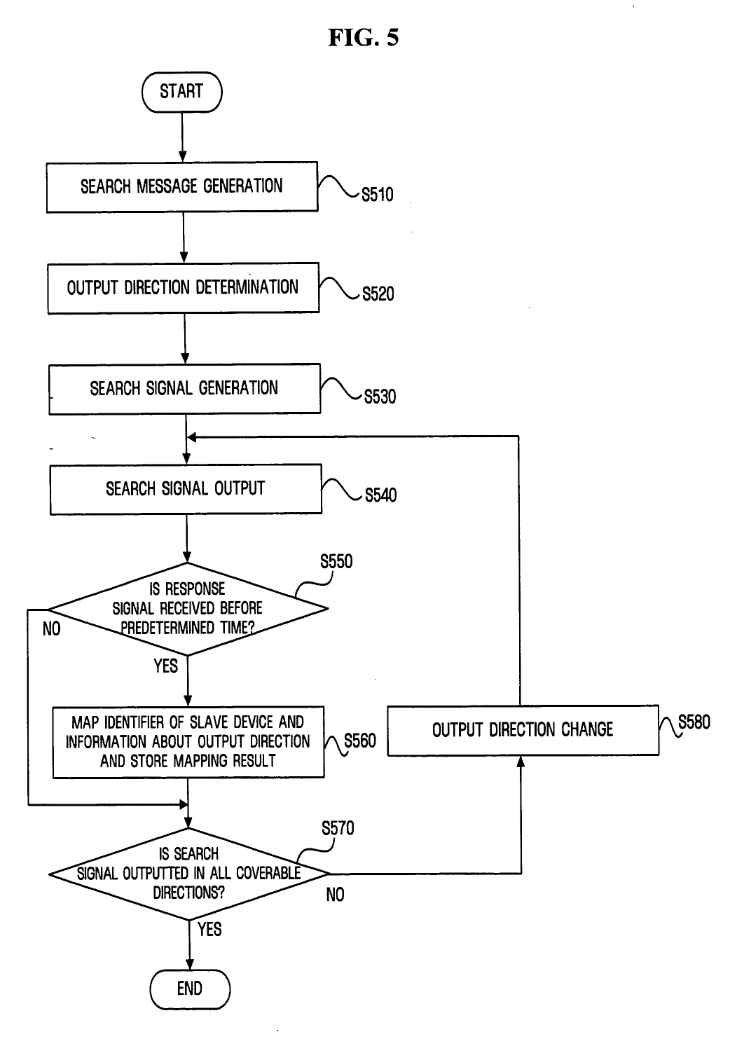

FIG. 5 is a flow diagram illustrating a process for searching for wireless communication devices according to one non-limiting embodiment of the present invention. The process as illustrated in FIG. 5 is performed by the master device 100.

First, the master device 100 generates a search message for searching for the slave device 200 (S510), and determines an output direction of a radio signal (S520). The output direction may be determined by adjusting the phases and amplitudes of each antenna element constituting an array antenna. The temporal priority of the search message generation (S510) and the output direction determination process (S520) do not limit the present invention.

Then, the master device 100 generates a radio signal (hereinafter, referred to as a search signal) including the search message (S530) and outputs the search signal in the output direction determined in S520 (S540).

After outputting the search signal, the master device 100 waits to receive a radio signal (hereinafter, referred to as a response signal) including a response message for the search message until a predetermined time passes (S550). If the response signal is received before the predetermined time passes, the master device 100 maps the identifier of a slave device having transmitted the response signal and information about the output direction of the search signal, and stores the mapping results (S560). Herein, the Media Access control (MAC) address of the slave device may be used as the identifier of the slave device, and information about the phase and amplitude of the array antenna when the search signal is outputted in S540 may be used as the information about the output direction of the search signal.

Then, the master device 100 determines if the search signal has been outputted in all directions coverable by the master device 100 (S570). If there exist directions in which the search signal has not been outputted, the master device 100 alters the output direction of the search signal by adjusting the phase and amplitude of the array antenna (S580) and outputs the search signal in the altered direction (S540). The master device 100 can alter output direction so that the output direction of radio signal can increase or decrease by a specific angle set in advance.

As a result of the determination in S570, if the search signal has been outputted in all coverable directions, the master device 100 completes the search operation.

If the predetermined time has passed without reception of the response signal in S550, the master device 100 determines if the search signal has been outputted in all coverable directions (S570).

In this way, the master device 100 can search for the slave devices 200 existing in a wide range, in spite of using high-frequency radio signal having a wavelength in the order of millimeters. The wide range represents a range in which, when radio signal having a wavelength in the order of millimeters are outputted in all directions, the radio signal cannot reach, but different radio signals sharply trimmed through an array antenna can reach. In detail, the wide range represents a range in which the slave devices 200 may exist around the master device 100, which may be about 10 m in the case of a home network. According to results of the search operation, the master device 100 can become aware of output direction of radio signal including data to be transmitted to the slave devices 200.

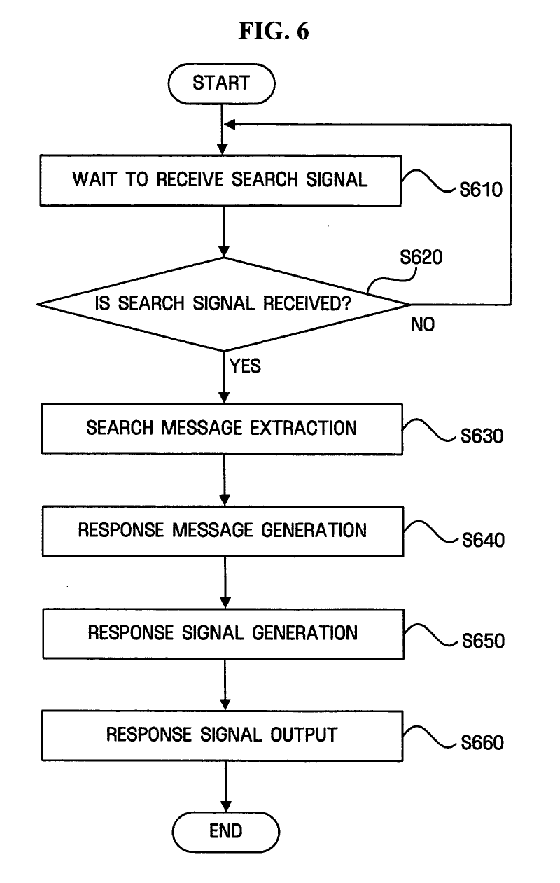

FIG. 6 is a flow diagram illustrating a process for searching for wireless communication devices in terms of the slave device 200 according to one non-limiting embodiment of the present invention. In the present embodiment, when the master device 100 operates as described in FIG. 5, an operation process of the slave device 200 will be described.

First, the slave device 200 waits to receive the search signal outputted from the master device 100 (S610). If the search signal is received (S620), the slave device 200 extracts a search message from the received search signal (S630). When the search signal is received, the slave device 200 receives the same radio signal having different phases from each antenna element of an array antenna. Herein, the slave device 200 can compute a Direction Of Arrival (DOA) by performing a Discrete Fourier Transform (DFT) for the received radio signal. Further, the slave device 200 can establish directivity of the received signal and optimize the array antenna in a corresponding direction by combining the amplitudes and phases of the received radio signal.

After extracting the search message from the received search signal, the slave device 200 generates a response message corresponding to the A search message (S640), and generates the radio signal (the afore-described response signal) including the generated response message (S650).

Then, the slave device 200 outputs the response signal (S660). That is, the slave device 200 outputs the response signal in the direction in which the search signal can be optimally received. In order to establish the output direction of the response signal, the slave device 200 can also adjust the phases and amplitudes of the array antenna, as in the case of the master device 100.

The non-limiting embodiments of FIGS. 5 and 6 describe a process by which the master device 100 and the slave device 200 transmit/receive the search signal and the response signal through a single radio channel. However, the present invention is not limited to these embodiments. That is, the master device 100 and the slave device 200 can also transmit/receive the search signal and the response signal through multiple different channels.

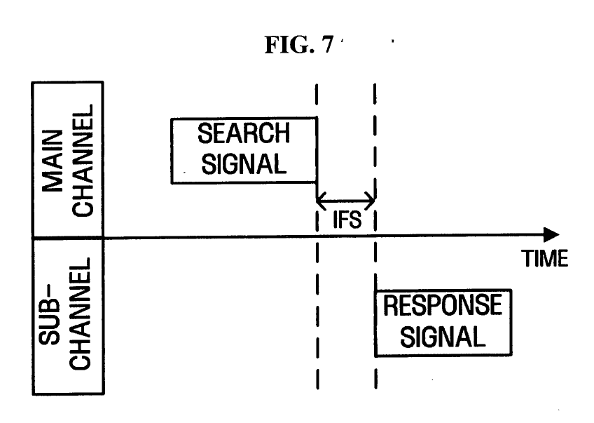

FIG. 7 is a diagram illustrating transmission of the search signal and the response signal through multiple channels by the master device 100 and the slave device 200. In the case of using multiple channels, a channel (hereinafter, referred to as main channel) transmitting the search signal and a channel (hereinafter, referred to as sub-channel) transmitting the response signal may use high-frequency radio signals having a wavelength in the order of millimeters. However, depending on embodiments, a main channel may use a radio signal of a high frequency band, and a sub-channel may use a radio signal of a band lower than that of the radio signal used for the main channel. For example, the sub-channel may selectively use one of the bands which do not cause interference with high frequency bands used by the main channel such as a 2.4 GHz band of an IEEE 802.11b, a 5 GHz band of an IEEE 802.111a and a Bluetooth communication band. In such a case, since the sub-channel may use radio signal having no directivity, when the sub-channel is used, transmission devices (may include both the master device 100 and the slave device 200) can omit beam forming and direction establishment processes in the case of using the main channel.

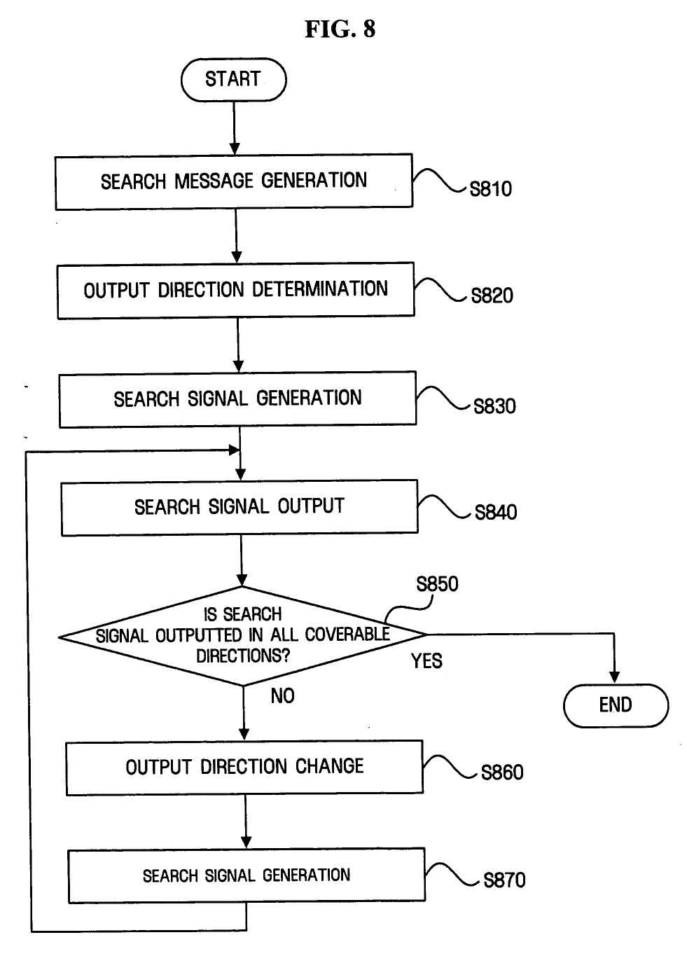

In this way, if the search signal and the response signal are transmitted/received through different channels, it is possible to more quickly search for wireless communication devices. This will be described in detail with reference to FIGS. 8 to 10.

FIG. 8 is a flow diagram illustrating a process for searching for wireless communication devices according to one non-limiting embodiment of the present invention. The process as illustrated in FIG. 8 is performed by the master device 100.

First, the master device 100 generates a search message for searching for the slave device 200 (S810), and determines an output direction of a radio signal to be outputted through the main channel (S820). Herein, the temporal priority of the search message generation (S810) and the output direction determination process (S820) do not limit the present invention. Further, the search message and information about the output direction may also be independent from each other, and the information about the output direction may also be included in the search message.

Then, the master device 100 generates a search signal including the search message and the information about the output direction (S830). The search signal further includes the information about the output direction, as compared to the search signal generated in S530 of FIG. 5, and the information about the output direction may include information about the phases and amplitudes of each antenna element of an array antenna.

Then, the master device 100 outputs the search signal in the output direction determined in S820 (S840). That is, the search signal includes information about direction in which the search signal is outputted.

If the search signal is outputted, the master device 100 determines if the search signal has been outputted in all directions coverable by the master device 100 (S850). If there exist directions in which the search signal has not been outputted, the master device 100 alters the output direction of the radio signal to be outputted through the main channel (S860) and generates search signal including both information about the altered output direction and the search message (S870). Then, the master device 100 outputs the search signal in the output direction altered in S860 (S840).

As described above, the master device 100 alters the output direction without waiting to receive a response signal for the search signal and outputs the search signal in all coverable directions. The search signal is outputted through the main channel, and the master device 100 performs the reception and processing operations of the response signal through the sub-channel, in parallel with the generation and output operations of the search signal.

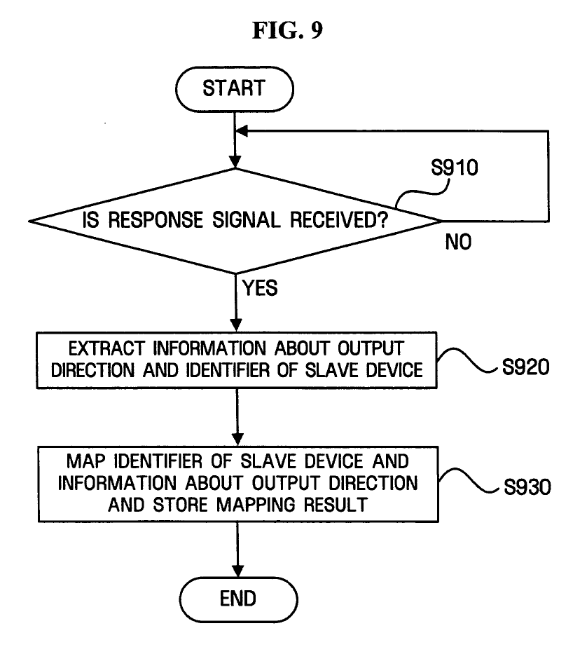

FIG. 9 is a flow diagram illustrating a process by which the master device 100 processes response signal transmitted from the slave device 200.

If the response signal for the search signal is received from the slave device 200 through the sub-channel (S910), the master device 100 extracts the identifier of the slave device 200 from the response signal (S920), wherein the slave device 200 has transmitted both information about output direction and the response signal. After the slave device 200 receives the search signal from the master device 100 through the process of FIG. 8, the slave device 200 inserts the information about output direction included in the search signal into the response signal. Accordingly, the master device 100 can extract the information about output direction from the response signal.

The master device 100 maps the extracted information about output direction and the identifier of the slave device 200, and stores the mapping results (S930).

The process of FIG. 9 is performed in parallel with the process of FIG. 8. This is possible because the search signal and the response signal are transmitted through different physical channels.

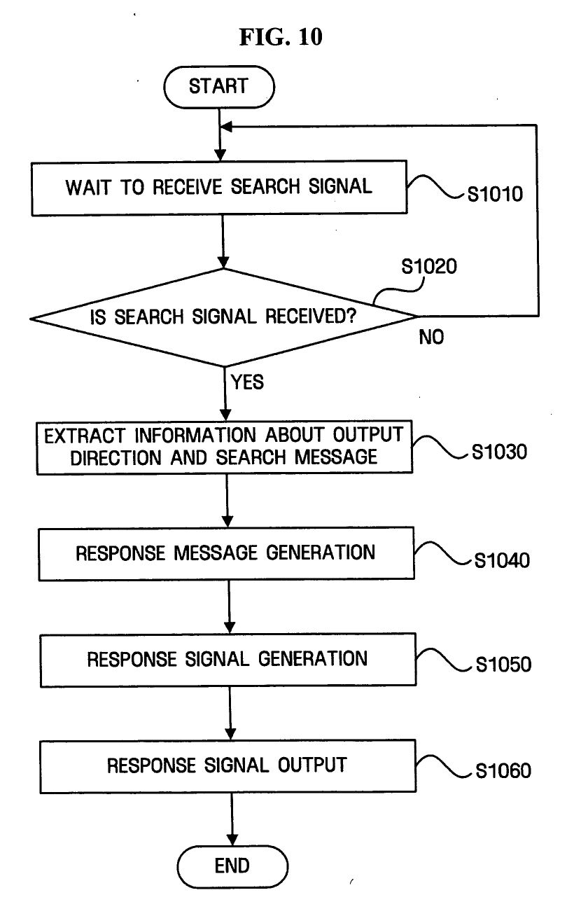

FIG. 10 is a flow diagram illustrating a process for searching for wireless communication devices in terms of the master device 100 according to one non-limiting embodiment of the present invention. In the present embodiment, when the master device 100 operates as described in FIGS. 8 and 9, an operation process of the slave device 200 will be described.

First, the slave device 200 waits to receive the search signal outputted from the master device 100 through the main channel (S1010). If the search signal is received through the main channel (S1020), the slave device 200 extracts both a search message and information about output direction from the received search signal (S1030).

Then, the slave device 200 generates a response message corresponding to the search message (S1040), and generates the radio signal (the afore-described response signal) including both the generated response message and the information about output direction extracted in S1030 (S1050).

Then, the slave device 200 outputs the response signal through the sub-channel (S1060). If the sub-channel uses high-frequency radio signal having a wavelength in the order of millimeters, the slave device 200 can output the response signal in the direction in which the search signal can be optimally received as in the case of S660 in FIG. 6. However, if the sub-channel uses low-frequency radio signals of 2.4 GHz, 5 GHz, etc., the slave device 200 may also output the response signal in an omni-direction. That is, when the sub-channel uses the low-frequency radio signals, it may be possible to omit a process by which the slave device 200 establishes the directivity of the response signal.

Hereinafter, the constructions of the master device 100 and the slave device 200 will be described, which perform the operations as described above.

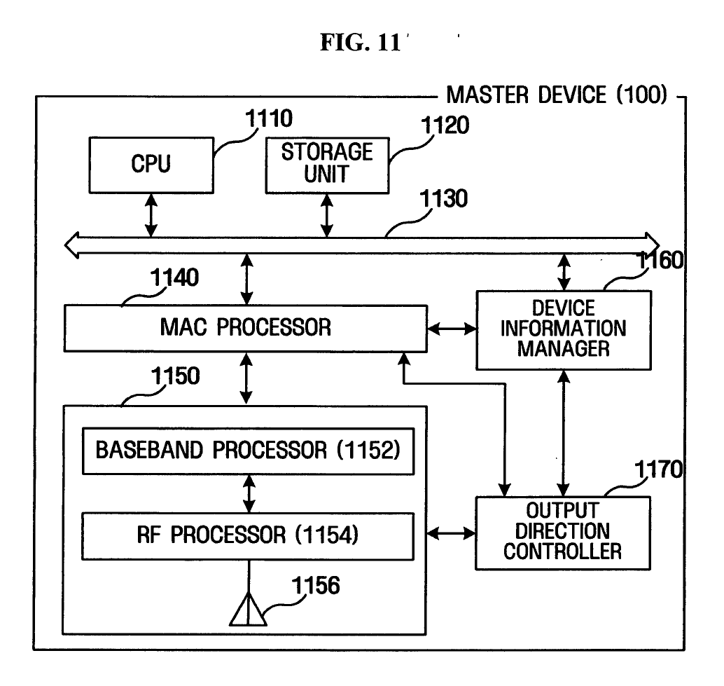

FIG. 11 is a block diagram illustrating the master device 100 according to one non-limiting embodiment of the present invention. The master device 100 includes a CPU 1110, a storage unit 1120, a Media Access Control (MAC) processor 1140, a transmission/reception unit 1150, a device information manager 1160 and an output direction controller 1170.

The CPU 1110 controls other elements connected to a bus 1130, and takes charge of processing in layers above a MAC layer among a general communication layer, wherein the layers include a Logical Link Control (LLC) layer, a network layer, a transport layer, an application layer, etc. Accordingly, the CPU 1110 processes reception data provided from the MAC processor 1140, or generates transmission data to provide it to the MAC processor 1140.

The storage unit 1120 stores the processed reception data or the generated transmission data. The storage unit 1120 stores both information about output direction managed by the device information manager 1160 and the identifiers of wireless communication devices mapped using the information. This storage unit 1120 may be realized as a non-volatile memory device such as a ROM, a PROM, an EPROM, an EEPROM and a flash memory, a volatile memory device such as a RAM, a storage medium such as a hard disk and an optical disk, or other memories known in corresponding fields.

The MAC processor 1140 generates a search message to provide it to the transmission/reception unit 1150. The search message is a request message for determining if the slave device 200 exists. Before providing the search message to the transmission/reception unit 1150, the MAC processor 1140 can determine the existence or absence of direction, in which a search signal has not been outputted, through the output direction controller 1170. If there exist directions in which a search signal has not been outputted, the MAC processor 1140 transmits the search message to the transmission/reception unit 1150 and simultaneously informs the output direction controller 1170 of the output of the search signal.

Further, the MAC processor 1140 extracts the identifier of the slave device 200, which has transmitted the response message, from the response message provided from the transmission/reception unit 1150. The identifier of the slave device 200 can be obtained from a field, in which the address of a transmission device is set, within an MAC header area of the response message.

The transmission/reception unit 1150 generates a radio signal (i.e. search signal) including the search message provided from the MAC processor 1140 and outputs the generated search signal. Further, the transmission/reception unit 1150 receives the response signal transmitted from the slave device 200, and transfers the response message included in the response signal to the MAC processor 1140. The transmission/reception unit 1150 may include a baseband processor 1152 for processing baseband signals, and a Radio Frequency (RF) processor 1154 for actually generating radio signals from the processed baseband signals and transmitting the generated radio signals to the air through an antenna 1156.

In more detail, the baseband processor 1152 performs frame formatting, channel coding, etc., and the RF processor 1154 performs operations including analog wave amplification, analog/digital signal conversion, modulation, etc. In a non-limiting embodiment, the antenna 1156 is constructed as an array antenna for implementation of beam steering. The array antenna may have a structure in which multiple antenna elements are arranged in a row. However, the present invention is not limited to this example. For example, the array antenna may also be constructed by multiple antenna elements disposed in a two-dimensional matrix form. In such a case, it is possible to perform beam steering more precisely and three-dimensionally.

The RF processor 1154 tunes the amplitudes and phases of each antenna element constituting the antenna 1156 by using information about an output direction, which is provided from the output direction controller 1170, before transmitting radio signals, thereby establishing the directivity of the radio signals to be outputted.

The device information manager 1160 maps the identifier of the slave device 200 having transmitted the response message and the information about output direction of the search signal, and stores the mapping results in the storage unit 1120. The identifier of the slave device 200 may be provided from the MAC processor 1140 having analyzed the response message, and the information about output direction may be provided from the output direction controller 1170. In a state in which the information about the output direction has been provided, if new information about an output direction is provided from the output direction controller 1170 even though there exists no identifier of the slave device 200 provided from the MAC processor 1140, the device information manager 1160 may discard previously provided information about output direction.

The output direction controller 1170 determines a direction in which the radio signal is to be outputted, and provides information about the determined output direction to the transmission/reception unit 1150, i.e. the RF processor 1154. Further, the output direction controller 1170 provides the device information manager 1160 with information about an output direction of the search signal.

The output direction controller 1170 can receive a report regarding the output or non-output of the search signal from the MAC processor 1140. If the output of the search signal is reported, the output direction controller 1170 provides the information about the output direction.

In a state in which the master device 100 has completed the search operation of wireless communication devices, when data to be transmitted to the slave device 200 exist, the MAC processor 1140 may request retrieval of the information about the output direction while transmitting the identifier of the corresponding slave device 200 to the device information manager 1160. The device information manager 1160 can retrieve the information about output direction mapped using the identifier of the slave device 200 from the storage unit 1120, and provide the retrieved information to the output direction controller 1170.

The output direction controller 1170 provides the information about output direction to the transmission/reception unit 1150, and the transmission/reception unit 1150 establishes the directivity of radio signal by using the information about output direction provided from the output direction controller 1170, wherein the radio signal includes the data transferred from the MAC processor 1140. Accordingly, the master device 100 can transmit required data to a target wireless communication device by using the radio signal having directivity. The operation process of the master device 100 as illustrated in FIG. 11 will be understood in more detail through the non-limiting embodiment of FIG. 5.

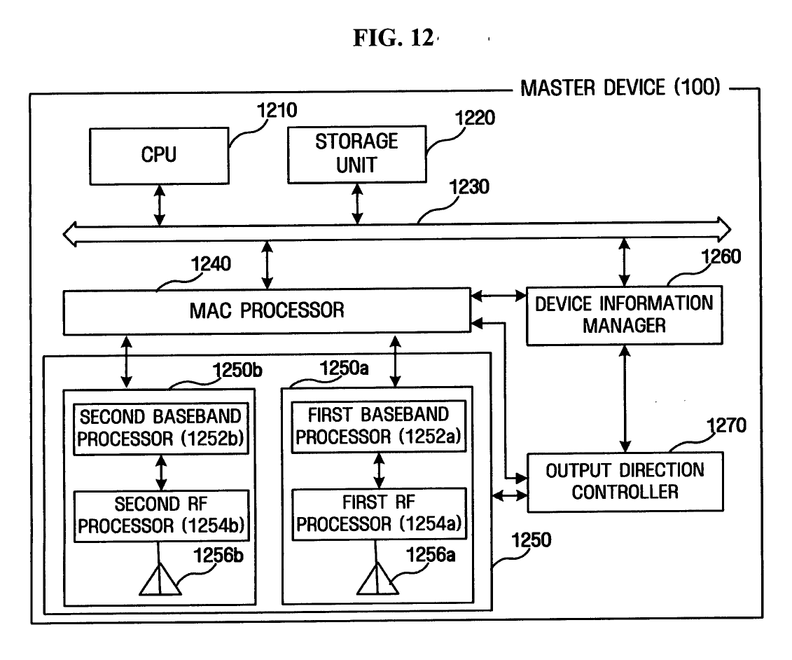

In the meantime, when the master device 100 uses two channels for transmission/reception of the search signal and the response signal, the master device 100 requires a transmission/reception unit capable of processing the two channels, which is illustrated in FIG. 12. The elements of the master device 100 as illustrated in FIG. 12 have functions similar to those of elements as described in FIG. 11. In the present embodiment, only the difference with the elements as described in FIG. 11 will be described.

The transmission/reception unit 1250 of the master device 100 as illustrated in FIG. 12 includes a first physical processor 1250a and a second physical processor 1250b. Of them, the first physical processor 1250a takes charge of communication of the main channel and the second physical processor 1250b takes charge of communication of the sub-channel. That is, the first physical processor 1250a takes charge of generation and output of radio signal including the search message transferred from an MAC processor 1240. The second physical processor 1250b receives the response signal from the slave device 200 and provides the MAC processor 1240 with the response message included in the response signal. Herein, the first physical processor 1250a uses high-frequency radio signal having a wavelength in the order of millimeters, but the second physical processor 1250b may use one of a high frequency band and a low frequency band depending on embodiments. In such a case, a first antenna 1256a included in the first physical processor 1250a is an array antenna, but a second antenna 1256b included in the second physical processor 1250b is not always an array antenna.

The MAC processor 1240 can insert information about an output direction into a search message when generating the search message. The information about the output direction may be provided from an output direction controller 1270. Accordingly, the search signal outputted from the first physical processor 1250a may include the information about the output direction.

Further, the MAC processor 1240 can receive the response message from the second physical processor 1250b, and extract both the identifier of a wireless communication device having transmitted the response message and the information about the output direction from the received response message. The extracted identifier and information about an output direction are provided to a device information manager 1260.

The device information manager 1260 maps the identifier and the information about the output direction, which are provided from the MAC processor 1240, and stores the mapping results in a storage unit 1220.

The operation process of the master device 100 as illustrated in FIG. 12 will be understood in more detail through the non-limiting embodiments of FIGS. 8 and 9.

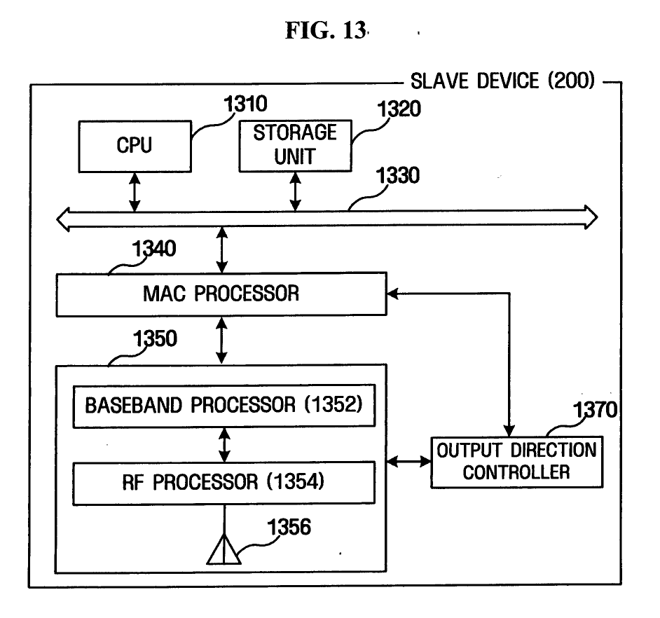

FIG. 13 is a block diagram illustrating the slave device 200 according to one non-limiting embodiment of the present invention. The slave device 200 has a construction similar to that of the master device 100. However, since the slave device 200 according to the non-limiting embodiment of the present invention puts emphasis on the output of the response signal for the search signal received from the master device 100, elements corresponding to the device information managers 1160 and 1260 existing in the master device 100 are not always necessary for the slave device 200. Hereinafter, only elements of the slave device 200 will be described, which are different from those of the master device 100. Descriptions not stated herein will be understood with reference to the descriptions about the master device 100.

A MAC processor 1340 generates a response message corresponding to a search message provided from a transmission/reception unit 1350, and provides it to the transmission/reception unit 1350.

The transmission/reception unit 1350 receives the search signal transmitted from the master device 100, extracts the search message from the search signal, and provides the extracted search message to the MAC processor 1340. The transmission/reception unit 1350 generates the radio signal (the afore-described response signal) including the response message provided from the MAC processor 1340, and outputs the generated radio signal. When the search signal is received, the transmission/reception unit 1350 can establish the directivity of radio signal received through optimization of an antenna 1356. The antenna 1356 is an array antenna.

An output direction controller 1370 manages information about a reception direction of the search signal, and controls the transmission/reception unit 1350 so that a response signal corresponding to the search signal can be outputted in a direction corresponding to the reception direction of the search signal. That is, the output direction controller 1370 can compute the output direction of the response signal by using the information about the reception direction of the search signal.

The operation process of the slave device 200 will be understood in more detail through the non-limiting embodiment of FIG. 6.

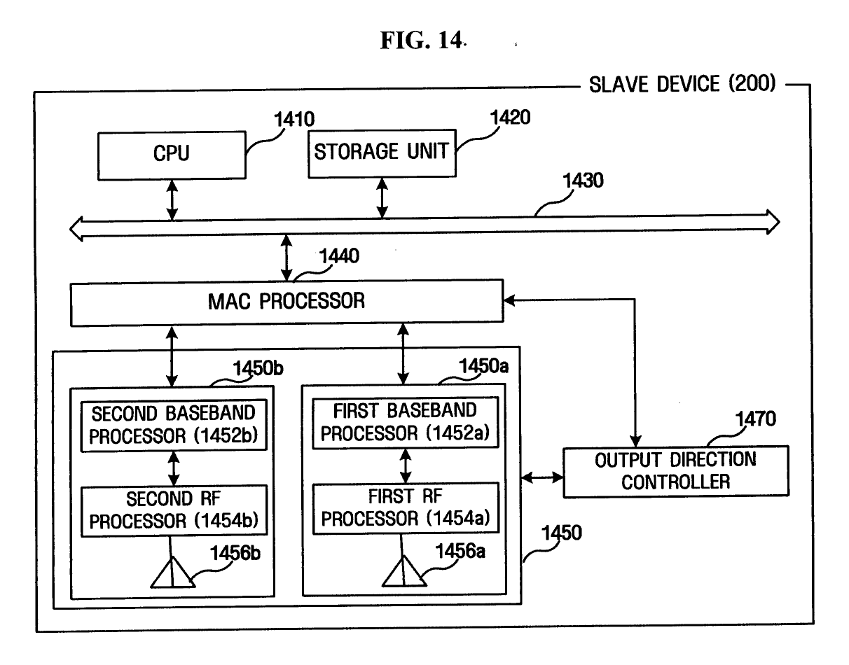

In the meantime, the slave device 200 may also use two channels for reception of the search signal and transmission of the response signal. In such a case, the slave device 200 requires a transmission/reception unit capable of processing the two channels, which is illustrated in FIG. 14. The transmission/reception unit 1450 of the slave device 200 as illustrated in FIG. 14 includes two physical processors 1450a and 1450b. The elements of the slave device 200 as illustrated in FIG. 14 have functions similar to those of elements in the non-limiting embodiment of FIG. 13. In the present embodiment, the slave device 200 receives the search signal by using the first physical processor 1450a and outputs the response signal by using the second physical processor 1450b.

Herein, the first physical processor 1450a uses a radio signal of a high frequency band having a wavelength in the order of millimeters, but the second physical processor 1450b may use one of a high frequency band and a low frequency band depending on embodiments. In such a case, a first antenna 1456a included in the first physical processor 1450a is an array antenna, but a second antenna 1456b included in the second physical processor 1450b is not always an array antenna.

The operation process of the slave device 200 as illustrated in FIG. 14 will be understood in more detail through the non-limiting embodiment of FIG. 10.

As described above, according to both a wireless communication device and a method for searching for a wireless communication device of the present invention, it is possible to easily search for wireless communication devices in a wireless network environment using ultrashort waves in the order of millimeters.

Although non-limiting embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. A method of searching for a wireless communication device, the method comprising:
outputting a search signal in multiple output directions; and
if a response signal for the search signal is received, mapping an identifier of the wireless communication device having transmitted the response signal and information about an output direction of the search signal.

2. The method of claim 1, wherein the outputting comprises:
generating a search message for searching for the wireless communication device; and
sequentially outputting the search signal including the search message in the multiple output directions.

3. The method of claim 1, wherein the outputting comprises outputting the search signal in an altered direction when the response signal is received before a threshold time passes or the response signal is not received even though the threshold time has passed, after the search signal is outputted in a predetermined output direction.

4. The method of claim 1, wherein the search signal and the response signal are transmitted through different channels.

5. The method of claim 4, wherein a first channel outputting the search signal has a frequency band higher than that of a second channel receiving the response signal, and the first channel has a bandwidth wider than that of the second channel.

6. The method of claim 1, wherein a channel outputting the search signal has a 60 GHz band.

7. The method of claim 1, wherein the response signal comprises the information about the output direction of the search signal.

8. The method of claim 1, wherein the mapping comprises:
extracting both the information about the output direction of the search signal and the identifier of the wireless communication device from the received response signal; and
mapping the extracted information about the output direction and the extracted identifier of the wireless communication device.

9. A method of searching for a wireless communication device, the method comprising:
receiving a search signal for searching for the wireless communication device;
generating a response signal corresponding to the search signal; and
outputting the response signal in an output direction corresponding to a reception direction of the search signal.

10. The method of claim 9, further comprising computing the output direction through the reception direction of the search signal.

11. The method of claim 9, wherein the search signal comprises information about the reception direction of the search signal, and the generating comprises:
extracting the information about the reception direction from the search signal; and
generating the response signal including the extracted information about the reception direction.

12. The method of claim 9, wherein the search signal and the response signal are transmitted through different channels.

13. The method of claim 12, wherein a first channel receiving the search signal has a frequency band higher than that of a second channel outputting the response signal, and the first channel has a bandwidth wider than that of the second channel.

14. The method of claim 9, wherein a channel receiving the search signal has a 60 GHz band.

15. A method of searching for a wireless communication device, the method comprising:
receiving a search signal for searching for the wireless communication device, the search signal having directivity;
extracting information about an output direction from the search signal;
generating a response signal including the extracted information about the output direction; and
outputting the response signal in an omni-direction.

16. The method of claim 15, wherein a first channel receiving the search signal has a frequency band higher than that of a second channel outputting the response signal, and the first channel has a bandwidth wider than that of the second channel.

17. The method of claim 16, wherein a channel receiving the search signal has a 60 GHz band.

18. A wireless communication device comprising:
a transmission/reception unit which outputs a search signal in multiple output directions and receives a response signal for the search signal; and
a device information manager which maps an identifier of another wireless communication device having transmitted the response signal and information about an output direction of the search signal.

19. The wireless communication device of claim 18, further comprising an array antenna which establishes directivity of the search signal.

20. The wireless communication device of claim 18, further comprising a Media Access Control (MAC) processor which generates a search message for searching for the another wireless communication device,
wherein the transmission/reception unit generates the search signal including the search message and sequentially outputs the generated search signal in the multiple output directions.

21. The wireless communication device of claim 18, wherein the transmission/reception unit outputs the search signal in an altered output direction when the response signal is received before a threshold time passes or the response signal is not received even though the threshold time has passed, after outputting the search signal in a predetermined output direction.

22. The wireless communication device of claim 18, wherein the transmission/reception unit comprises:
a first physical processor which outputs the search signal through a first communication channel; and
a second physical processor which receives the response signal through a second communication channel.

23. The wireless communication device of claim 22, wherein the first communication channel has a frequency band higher than that of the second communication channel, and the first communication channel has a bandwidth wider than that of the second communication channel.

24. The wireless communication device of claim 18, wherein a channel outputting the search signal has a 60 GHz band.

25. The wireless communication device of claim 18, wherein the response signal comprises the information about the output direction of the search signal.

26. The wireless communication device of claim 25, further comprising a Media Access control (MAC) processor which extracts both the information about output direction of the search signal and the identifier of the another wireless communication device,
wherein the device information manager maps the information about the output direction and the identifier of the another wireless communication device.

27. A wireless communication device comprising:
a Media Access Control (MAC) processor which generates a response message corresponding to a search message for searching for another wireless communication device; and
a transmission/reception unit which receives a search signal including the search message, provides the search message to the MAC processor, generates a response signal including the response message, and outputs the response signal in an output direction corresponding to a reception direction of the search signal.

28. The wireless communication device of claim 27, further comprising an array antenna which establishes directivity to receive the search signal.

29. The wireless communication device of claim 27, further comprising an output direction controller which computes the output direction through the reception direction of the search signal.

30. The wireless communication device of claim 27, wherein the search message comprises information about the reception direction of the search signal, and the MAC processor extracts the information about the reception direction included in the search message, and generates the response message comprising the extracted information about the reception direction.

31. The wireless communication device of claim 27, wherein the transmission/reception unit comprises:
a first physical processor which outputs the search signal through a first communication channel; and
a second physical processor which receives the response signal through a second communication channel.

32. The wireless communication device of claim 31, wherein the first communication channel has a frequency band higher than that of the second communication channel, and the first communication channel has a bandwidth wider than that of the second communication channel.

33. The wireless communication device of claim 27, wherein a channel receiving the search signal has a 60 GHz band.

34. A wireless communication device comprising:
a Media Access Control (MAC) processor which extracts information about an output direction from a search message and generates a response message including the extracted information about output direction; and
a transmission/reception unit which receives a search signal having directivity and including the search message, provides the search message to the MAC processor, generates a response signal including the response message, and outputs the response signal in an omni-direction.

35. The wireless communication device of claim 34, further comprising an array antenna which establishes directivity of the search signal.

36. The wireless communication device of claim 34, wherein the transmission/reception unit comprises:
a first physical processor which outputs the search signal through a first communication channel; and
a second physical processor which receives the response signal through a second communication channel.

37. The wireless communication device of claim 34, wherein a channel receiving the search signal has a 60 GHz band.
